(19) United States
(12) Patent Application Publication
(10) Pub. No.: US 2026/0241921 A1
(43) Pub. Date: Aug. 20, 2026

(54) VEHICLE CONTROL APPARATUS AND VEHICLE CONTROL METHOD

(71) Applicant: TOYOTA JIDOSHA KABUSHIKI KAISHA, Toyota-shi (JP)

(72) Inventor: Hiroki FURUTA, Toki-shi (JP)

(73) Assignee: TOYOTA JIDOSHA KABUSHIKI KAISHA, Toyota-shi (JP)

(21) Appl. No.: 19/355,195

(22) Filed: Oct. 10, 2025

(30) Foreign Application Priority Data
Feb. 19, 2025 (JP) 2025-024853

(51) Int. Cl. B60W 30/045; B60W 30/02; B60W 40/109; B60W 50/00; B60W 60/00

(52) U.S. Cl. CPC B60W 30/045; B60W 30/025; B60W 40/109; B60W 2050/0024; B60W 60/0013; B60W 2520/125; B60W 2720/18

(57) ABSTRACT

A vehicle control apparatus that controls a vehicle behavior control device that is able to control a movement of a vehicle body in a roll direction, the vehicle control apparatus includes an estimation unit configured to estimate a lateral acceleration generated in a vehicle, and a gain calculation unit configured to calculate information indicating a roll control gain for driving the vehicle behavior control device to move the vehicle body in the roll direction based on the lateral acceleration estimated by the estimation unit. The estimation unit is configured to estimate the lateral acceleration based on information indicating a previous roll control gain.

### CROSS-REFERENCE TO RELATED APPLICATION

This application claims priority to Japanese Patent Application No. 2025-024853 filed on Feb. 19, 2025. The disclosure of the above-identified application, including the specification, drawings, and claims, is incorporated by reference herein in its entirety.

### BACKGROUND

### 1. Technical Field

The present disclosure relates to a technique for executing roll control of a vehicle body.

### 2. Description of Related Art

Japanese Unexamined Patent Application Publication No. 2017-105395 (JP 2017-105395 A) discloses a vehicle control apparatus. The apparatus includes a plurality of units, and first, a “lateral acceleration estimation unit” estimates a lateral acceleration acting on a vehicle based on equivalent cornering power stored in a memory, and traveling state information including a front wheel steering angle, a rear wheel steering angle, a vehicle speed, and a yaw rate. Next, a “tire characteristic change determination unit” determines that a change has occurred in the equivalent cornering power when a deviation between the lateral acceleration that is estimated and the lateral acceleration that is measured exceeds a threshold value. Further, a “tire characteristic value estimation unit” estimates actual equivalent cornering power based on the lateral acceleration that is measured and the traveling state information. Finally, a “tire characteristic value correction unit” corrects the equivalent cornering power stored in the memory based on the equivalent cornering power that is estimated.

A control amount of an active stabilizer is calculated based on a lateral acceleration estimated by using the equivalent cornering power that is corrected.

### SUMMARY

In the technique disclosed in JP 2017-105395 A, the active stabilizer device causes the vehicle body to roll during steering. At this time, suspension characteristics, such as a toe angle, a camber angle, and a lateral displacement of a contact point, are changed.

As a result, the equivalent cornering power that is estimated deviates from an actual value. Further, the deviation between the lateral acceleration estimated by using the equivalent cornering power that is estimated and the actual lateral acceleration is likely to increase.

An object of the present disclosure is to provide a technique for accurately estimating a lateral acceleration of a vehicle.

In order to solve the above problem, an aspect of the present disclosure is a vehicle control apparatus that controls a vehicle behavior control device that is able to control a movement of a vehicle body in a roll direction, the vehicle control apparatus including an estimation unit configured to estimate a lateral acceleration generated in a vehicle, and a gain calculation unit configured to calculate information indicating a roll control gain for driving the vehicle behavior control device to move the vehicle body in the roll direction based on the lateral acceleration estimated by the estimation unit,
in which the estimation unit is configured to estimate the lateral acceleration based on information indicating a previous roll control gain.

Another aspect of the present disclosure is a vehicle control method. The method is a vehicle control method executed by a vehicle control apparatus that controls a vehicle behavior control device that is able to control a movement of a vehicle body in a roll direction, the vehicle control method including
estimating a lateral acceleration generated in a vehicle, and
calculating information indicating a roll control gain for driving the vehicle behavior control device to move the vehicle body in the roll direction based on the lateral acceleration that is estimated,
in which in the estimating, the lateral acceleration is estimated based on information indicating a previous roll control gain.

According to the present disclosure, the technique for accurately estimating the lateral acceleration of the vehicle can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a functional configuration of a vehicle control system of an embodiment;

FIG. 2 is a diagram showing a relationship between a roll control gain and an equivalent cornering power;

FIG. 3 is a diagram showing a relationship between the roll control gain and a delay time constant of a lateral force;

FIG. 4 is a diagram showing a turning state of a vehicle in a two-wheel model; and

FIG. 5 is a flowchart of the vehicle control method of the embodiment.

### DETAILED DESCRIPTION OF EMBODIMENTS

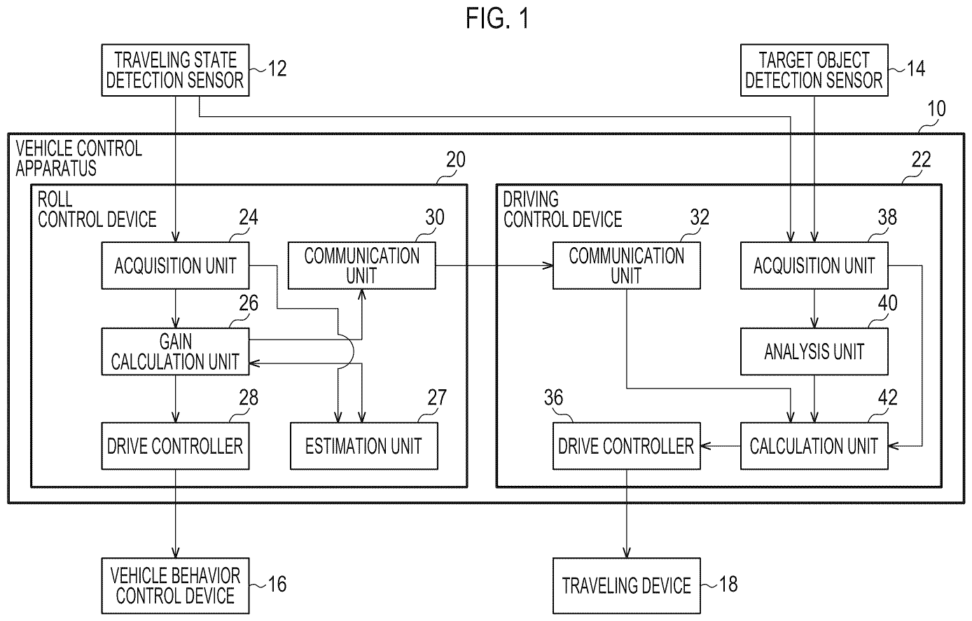

FIG. 1 is a diagram showing a functional configuration of a vehicle control system 1 of an embodiment. In FIG. 1, each of the elements described as a functional block that performs various types of processing can be configured as follows. In terms of hardware, the elements can be configured with a circuit block, a memory, and other LSIs. In terms of software, the elements are realized by a program or the like loaded in the memory. Therefore, it is understood by those skilled in the art that the functional blocks can be realized in various forms by solely hardware, solely software, or a combination thereof, and are not limited to any of the forms.

The vehicle control system 1 executes autonomous driving control in which the vehicle can be driven autonomously. The vehicle control system 1 executes, in the autonomous driving control, follow control of following a preceding vehicle and cruise control of traveling in a traveling lane at a vehicle speed that is predetermined. The vehicle control system 1 includes a vehicle control apparatus 10, a traveling state detection sensor 12, a target object detection sensor 14, a vehicle behavior control device 16, and a traveling device 18.

The traveling state detection sensor 12 detects a traveling state of the vehicle. The traveling state detection sensor 12 includes a vehicle speed sensor, a steering angle sensor, an acceleration sensor, a brake pressure sensor, and the like, and transmits a result of detecting the traveling state of the vehicle to the vehicle control apparatus 10.

The target object detection sensor 14 includes an in-vehicle camera, a millimeter wave radar, an optical radar, a sound wave sensor, and the like, and detects a target object located around the vehicle. The target object detection sensor 14 may transmit information indicating a positional relationship between the target object and the vehicle as information related to the target object to the vehicle control apparatus 10, or may transmit a mere sensor value as information related to the target object to the vehicle control apparatus 10.

The vehicle behavior control device 16 is, for example, an active stabilizer device. The active stabilizer device may be provided on both a front wheel side and a rear wheel side, or may be provided solely on the front wheel side. The active stabilizer device is connected to right and left wheels, for example, lower arms at both end portions. The active stabilizer device includes a right stabilizer bar, a left stabilizer bar, and an electric actuator that connects the right stabilizer bar and the left stabilizer bar to each other such that the right stabilizer bar and the left stabilizer bar can be relatively rotated. The roll control device 20 can apply a force in the roll direction to the vehicle body by driving the electric actuator to relatively rotate the right stabilizer bar and the left stabilizer bar.

In addition, the vehicle behavior control device 16 may be an active suspension device provided in each of the wheels. The active suspension device may be an air suspension device, or a full active suspension device that is electric or hydraulic. The active suspension device can move the vehicle body in the roll direction by displacing one or both of the right and left wheel sides in the vertical direction by the control of the roll control device 20. In any case, the vehicle behavior control device 16 controls the movement of the vehicle body in the roll direction.

The traveling device 18 includes a drive unit configured to apply a drive force to wheels and rotate the wheels to cause the vehicle to travel forward, a steering unit configured to steer the wheels, and a braking unit configured to apply a braking force to the wheels. The drive unit may be an engine, a motor, or a combination thereof. The traveling device 18 may be driven by the operation of the driver or may be driven by the autonomous driving control. The autonomous driving control is executed in response to an instruction from the driver.

The vehicle control apparatus 10 includes a roll control device 20 and a driving control device 22. The roll control device 20 executes roll control of controlling the vehicle behavior control device 16 to move the vehicle body in the roll direction. The driving control device 22 drives the traveling device 18 to execute the autonomous driving control. The roll control device 20 and the driving control device 22 can communicate with each other by in-vehicle communication. The roll control device 20 and the driving control device 22 are not limited to being separate electronic control units (ECUs), and may be a single ECU.

The roll control device 20 includes an acquisition unit 24, a gain calculation unit 26, an estimation unit 27, a drive controller 28, and a communication unit 30. The acquisition unit 24 acquires a detection result of the traveling state detection sensor 12.

The gain calculation unit 26 acquires information indicating a roll control gain for driving the vehicle behavior control device 16 based on the lateral acceleration of the vehicle. The information indicating the roll control gain is an index indicating the magnitude with which the vehicle behavior control device 16 moves the vehicle body in the roll direction, and is information indicating the magnitude of the roll control executed by the vehicle behavior control device 16 to suppress the speed of the vehicle body in the roll direction. The information indicating the roll control gain may be an absolute value of a force generated by the actuator of the vehicle behavior control device 16. In addition, the information indicating the roll control gain may be a torque absolute value of the actuator. Further, the information indicating the roll control gain may be a ratio of the lateral acceleration to the force or the torque absolute value of the actuator. Further, the information indicating the roll control gain may be a roll angle of the vehicle body. Furthermore, the information indicating the roll control gain may be a target roll angle with respect to the lateral acceleration.

The drive controller 28 drives the vehicle behavior control device 16 in accordance with the roll control gain. As a result, the inclination of the vehicle body in the roll direction during turning of the vehicle is suppressed, and a planar motion characteristic is improved.

The estimation unit 27 estimates the lateral acceleration of the vehicle used by the gain calculation unit 26 based on the detection result of the traveling state detection sensor 12. The lateral acceleration of the vehicle body disposed on a sprung mass is the acceleration in the vehicle right and left direction that is orthogonal to a vehicle front-rear direction.

Here, when the roll control is executed during steering by the vehicle behavior control device 16, the suspension characteristics such as the toe angle, the camber angle, and the lateral displacement of the contact point are changed, and thus the turning characteristics are changed. In addition, a change amount of the turning characteristic is not constant, and is changed by the roll control gain. Depending on the change amount of the turning characteristic, the deviation between the lateral acceleration that is estimated and the actual lateral acceleration is likely to be large, and the roll control is likely to be executed with the lateral acceleration deviated significantly more than the actual lateral acceleration. Therefore, the estimation unit 27 estimates the lateral acceleration based on the previous roll control gain, and the gain calculation unit 26 calculates the current roll control gain based on the lateral acceleration that is estimated. The previous roll control gain is the roll control gain calculated by the gain calculation unit 26 in the previous control cycle.

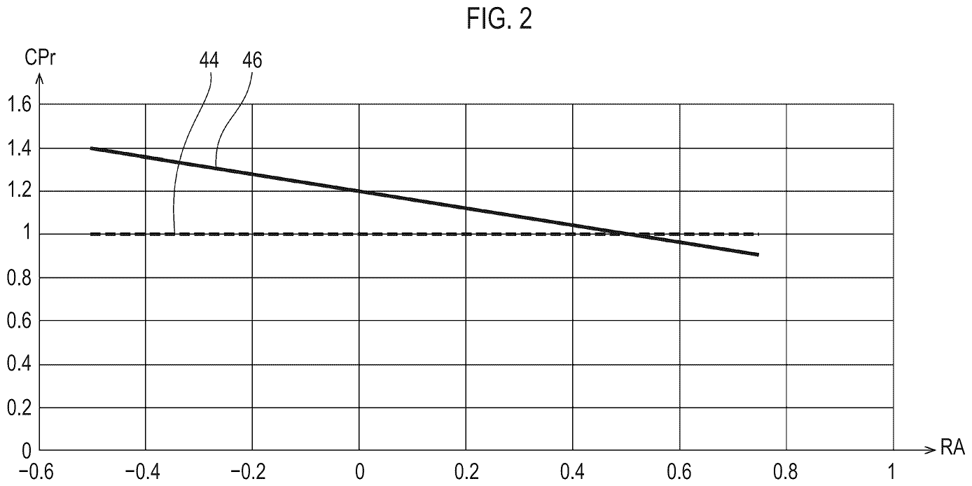

FIG. 2 is a diagram showing a relationship between a roll control gain and an equivalent cornering power. The horizontal axis in FIG. 2 is a roll angle RA as a roll control gain, and a vertical axis in FIG. 2 is an equivalent cornering power ratio CPr.

The roll angle RA is a roll angle RA (the unit is [deg/G]) in accordance with the detected lateral acceleration, and may be a target control value of the vehicle behavior control device 16. The roll angle RA is zero in a horizontal state, and increases as the vehicle body tilts toward the outside of the turn when the vehicle turns. The tilt toward the outside of the turn may be referred to as a positive roll angle.

An equivalent cornering power ratio 44 that is normal is a ratio of the equivalent cornering power when the roll control is not executed to the equivalent cornering power when the roll control is not executed, and is 1. An equivalent cornering power ratio 46 is a ratio of the equivalent cornering power when the roll control is executed to the equivalent cornering power when the roll control is not executed.

The equivalent cornering power ratio 46 indicates that the equivalent cornering power decreases as the roll angle RA increases. That is, when the control for rolling the vehicle body toward the outside of the turn is executed, the equivalent cornering power is reduced, and a grip force of the wheels is reduced. There is no deviation of the equivalent cornering power by the roll control at the roll angle RA at an intersection of the equivalent cornering power ratio 44 and the equivalent cornering power ratio 46.

Information indicating a relationship between a roll angle RA that is a roll control gain and the equivalent cornering power may be stored in advance in the roll control device 20. That is, the estimation unit 27 may estimate the equivalent cornering power of the vehicle behavior control device 16 in accordance with the roll control gain based on a two-dimensional map stored in advance. The relationship is generated by an experiment for each vehicle model or the like. In addition, the estimation unit 27 may estimate the equivalent cornering power in accordance with the roll control gain by using an equation.

The information indicating the relationship between the roll control gain and the equivalent cornering power is a relationship in which the equivalent cornering power decreases as the roll control gain increases the tilt of the vehicle body toward the outside of the turn of the vehicle. Accordingly, the equivalent cornering power that changes in accordance with the roll control gain can be appropriately estimated. When the geometry of the suspension and the tire characteristics are significantly different from those of a general vehicle, the relationship shown in FIG. 2 may not be applied.

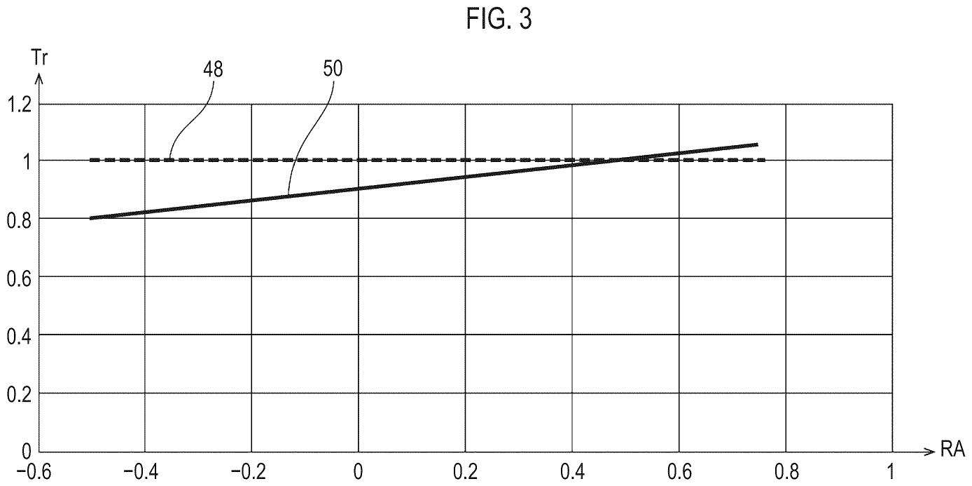

FIG. 3 is a diagram showing a relationship between a roll control gain and a delay time constant of a lateral force. The horizontal axis in FIG. 3 is the same as in FIG. 2, and is the roll angle RA, and the vertical axis in FIG. 3 is a delay time constant ratio Tr of the lateral force. The delay time constant of the lateral force indicates a responsiveness of the lateral force that occurs in the wheels with respect to the slip angle or the steering angle.

A normal delay time constant ratio 48 of the lateral force is a ratio of the delay time constant of the lateral force when the roll control is not executed to the delay time constant of the lateral force when the roll control is not executed, and is 1. The delay time constant ratio 50 of the lateral force is a ratio of the delay time constant of the lateral force when the roll control is executed to the delay time constant of the lateral force when the roll control is not executed.

The delay time constant ratio 50 of the lateral force indicates that the delay time constant of the lateral force increases as the roll angle RA increases. That is, when the control for rolling the vehicle body toward the outside of the turn is executed, the delay time constant of the lateral force is larger than the normal value.

The estimation unit 27 estimates the delay time constant of the lateral force of the vehicle behavior control device 16 in accordance with the roll control gain based on information indicating the relationship between the roll control gain and the delay time constant of the lateral force that is stored in advance. The information indicating the relationship between the roll control gain and the delay time constant of the lateral force may be stored in the roll control device 20 in a format of an equation or a map.

The information indicating the relationship between the roll control gain and the delay time constant of the lateral force is a relationship in which the delay time constant of the lateral force increases as the roll control gain increases the tilt of the vehicle body toward the outside of the turn of the vehicle. Accordingly, the delay time constant of the lateral force that changes in accordance with the roll control gain can be appropriately estimated.

The estimation unit 27 estimates the lateral acceleration acting on the vehicle based on the turning characteristic of the vehicle that is estimated. The estimation unit 27 estimates the lateral acceleration based on the equivalent cornering power ratio CPr that is estimated and the delay time constant ratio Tr of the lateral force. As a result, the lateral acceleration to which the influence of the roll control is applied can be accurately estimated.

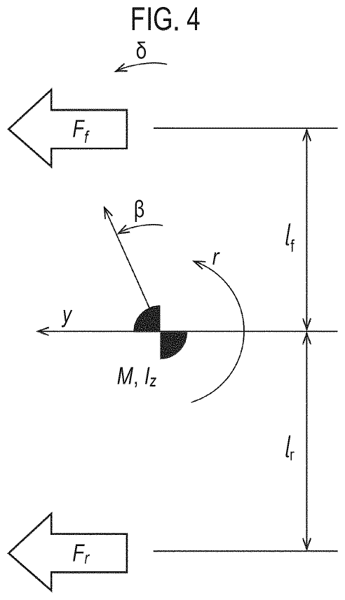

FIG. 4 is a diagram showing a turning state of a vehicle in a two-wheel model.

In the two-wheel model in which the vehicle is simplified, the lateral force F_{f} of the front wheels and the lateral force Fᵣ of the rear wheels are calculated by the following Equations (1) and (2). In the two-wheel model that is simplified, the center of gravity is positioned between one front wheel and one rear wheel.

$${F}_{f} = {C}_{pf} {C}_{ef} ( δ - β - {r 1}_{f} / V ) / ( 1 + {T}_{f} {T}_{cf} S ) \qquad Equation ( 1 )$$

C_{pf} is the normal equivalent cornering power of the front wheels, and is a value that is not corrected by C_{cf}. C_{cf} is an equivalent cornering power ratio of the front wheels in accordance with the roll control gain. δ is a steering angle. β is a slip angle. r is a yaw angle at the center of gravity. lf is a distance from the center of gravity to the front wheels, V is a vehicle speed. T_{f} is a normal delay time constant of the lateral force of the front wheels, and is a value that is not corrected by T_{cf}. T_{cf} is a delay time constant ratio of the lateral force of the front wheels in accordance with the roll control gain. S is a Laplace operator set in advance.

$${F}_{r} = {C}_{pr} {C}_{er} ( δ - β - {r 1}_{r} / V ) / ( 1 + {T}_{r} {T}_{cr} S ) \qquad Equation ( 2 )$$

Cₚᵣ is the normal equivalent cornering power of the rear wheels, and is a value that is not corrected by C_{cr}. C_{cr} is an equivalent cornering power ratio of the rear wheels in accordance with the roll control gain. Tᵣ is a normal delay time constant of the lateral force of the rear wheels, and is a value that is not corrected by T_{cr}. T_{cr} is a delay time constant ratio of a lateral force of the rear wheels in accordance with the roll control gain.

By Equations (1) and (2), the lateral force of the wheels corrected by the equivalent cornering power ratio and the delay time constant ratio of the lateral force is calculated. In Equations (1) and (2), the lateral force of the wheels can be corrected with solely one of the equivalent cornering power ratio and the delay time constant ratio of the lateral force. The T_{f} and the Tᵣ may not coincide with the actual numerical values, and may be adjusted to be shorter than the actual vehicle in order to advance the phase. The equivalent cornering power ratios C_{cf}, C_{cr} are 1 when the roll control is not executed. The lateral force delay time constant ratios T_{cf}, T_{cr} are 1 when the roll control is not executed.

The corrected lateral force of the wheels can be substituted into the equations of motion of the following Equations (3), (4), and (5) to calculate the lateral acceleration y″, the angular velocity r′ of the yaw angle, and the angular velocity β′ of the slip angle at the center of gravity of the vehicle. Therefore, the vehicle motion to which the influence of the roll control gain is added is estimated.

$${y}^{″} = ( 2 {F}_{f} + 2 {F}_{r} ) / M \qquad Equation ( 3 )$$

$${r}^{′} = ( {21}_{f} {F}_{f} - {21}_{r} {F}_{r} ) / {I}_{z} \qquad Equation ( 4 )$$

$${β}^{′} = {y}^{″} / V - r$$

y is a lateral displacement of the center of gravity, and y″ that is a second derivative of y is a lateral acceleration. M is a vehicle weight. I_{z} is an inertia moment of the center of gravity. r is a yaw angle.

By Equation (3), the lateral acceleration is calculated by the equivalent cornering power ratio and the delay time constant ratio of the lateral force in accordance with the roll control gain. Although the estimation unit 27 estimates the lateral acceleration in a simple two-wheel model to reduce the calculation amount, the present disclosure is not limited to the aspect, and the lateral acceleration may be estimated in a four-wheel model.

The estimation unit 27 estimates the lateral acceleration in accordance with the change in the turning characteristic by the previous roll control gain. The gain calculation unit 26 calculates the current roll control gain in accordance with the lateral acceleration estimated by the estimation unit 27. The drive controller 28 controls the vehicle behavior control device 16 in accordance with the current roll control gain.

The driving control device 22 includes a communication unit 32, a drive controller 36, an acquisition unit 38, an analysis unit 40, and a calculation unit 42. The acquisition unit 38 acquires the detection result of the traveling state detection sensor 12 and the detection result of the target object detection sensor 14. The acquisition unit 38 acquires the destination and the map information from a navigation device and acquires position information of the vehicle calculated by using a global positioning satellite system.

The analysis unit 40 recognizes information related to the target object, for example, the position information of the target object, based on the detection result of the target object detection sensor 14. The analysis unit 40 may identify the target object from a captured image by using a method of a neural network, for example, a method of deep learning. The target object is an obstacle or a roadside installation. The analysis unit 40 recognizes a preceding vehicle for following or a position of a traveling lane, and generates information related to a traveling target. The analysis unit 40 may set a target position and a target yaw angle in the autonomous driving control.

The calculation unit 42 calculates a target control value to be executed in the autonomous driving control such that the vehicle reaches the target position and the target yaw angle based on an acquisition result of the acquisition unit 38 and an analysis result by the analysis unit 40. The target control value includes a target vehicle speed, a target steering angle, a target deceleration, and the like.

When the vehicle behavior control device 16 executes the roll control during steering, the comfort of the occupant is improved, but the turning characteristic is changed due to the change in the suspension characteristic such as a toe angle, a camber angle, and a lateral displacement of the contact point. In addition, a change amount of the turning characteristic is not constant, and is changed by the roll control gain. The vehicle control apparatus 10 of the embodiment adjusts the target steering angle in the autonomous driving control based on information indicating the roll control gain.

The communication unit 32 acquires the information indicating the roll control gain from the roll control device 20. The calculation unit 42 estimates the turning characteristic of the vehicle in accordance with the roll control gain. The turning characteristic estimated by the calculation unit 42 is based on the suspension characteristic, and may be at least one of the equivalent cornering power of the wheels at the time of the roll control and the delay time constant of the lateral force. The calculation unit 42 estimates the lateral acceleration based on the estimated turning characteristic, and calculates the target steering angle of the autonomous driving control based on the lateral acceleration that is estimated. As a result, the comfort of the driver can be improved by the roll control, and the tracking performance of the target trajectory in the autonomous driving control can be improved. The drive controller 36 controls the traveling device 18 in accordance with the target control value calculated by the calculation unit 42.

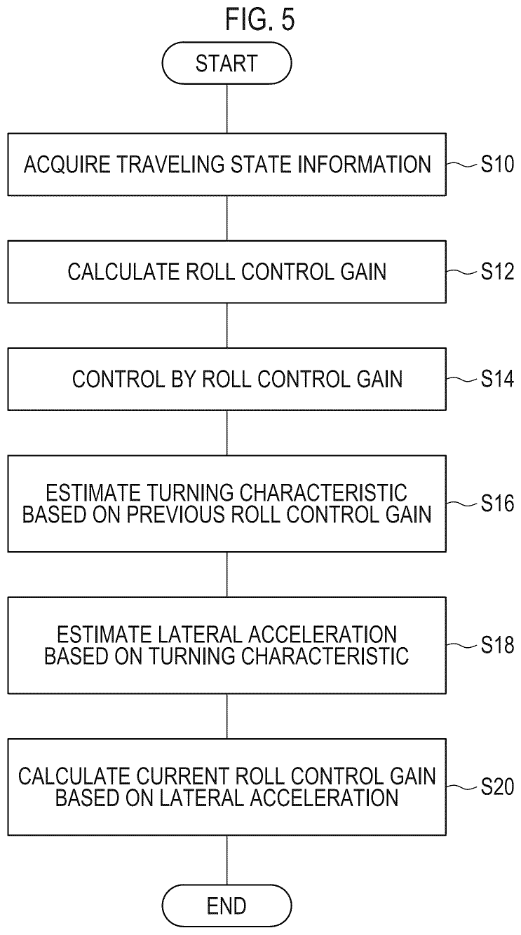

FIG. 5 is a flowchart of the vehicle control method of the embodiment. The acquisition unit 24 of the roll control device 20 acquires the traveling state information from the traveling state detection sensor 12 (S10). The gain calculation unit 26 calculates the roll control gain based on the lateral acceleration estimated by the estimation unit 27 in order to suppress the movement of the vehicle body in the roll direction (S12).

The estimation unit 27 estimates the turning characteristic of the vehicle in accordance with the roll control gain used in the previous control, specifically, the equivalent cornering power ratio and the delay time constant ratio of the lateral force (S16). The estimation unit 27 estimates the lateral acceleration acting on the vehicle based on the turning characteristic that is estimated (S18). The gain calculation unit 26 calculates the roll control gain to be used in the current control based on the lateral acceleration that is estimated (S20). The drive controller 28 controls the vehicle behavior control device 16 in accordance with the current roll control gain.

The present disclosure has been described based on the embodiments. The present disclosure is not limited to the embodiments described above, and can be modified as various design changes and the like based on the knowledge of those skilled in the art.

What is claimed is:

1. A vehicle control apparatus that controls a vehicle behavior control device that is able to control a movement of a vehicle body in a roll direction, the vehicle control apparatus comprising:
an estimation unit configured to estimate a lateral acceleration generated in a vehicle; and
a gain calculation unit configured to calculate information indicating a roll control gain for driving the vehicle behavior control device to move the vehicle body in the roll direction based on the lateral acceleration estimated by the estimation unit,
wherein the estimation unit is configured to estimate the lateral acceleration based on information indicating a previous roll control gain.

2. The vehicle control apparatus according to claim 1, wherein the estimation unit is configured to estimate a turning characteristic of the vehicle in accordance with the previous roll control gain, and to estimate the lateral acceleration based on the turning characteristic that is estimated.

3. The vehicle control apparatus according to claim 2, wherein the estimation unit is configured to estimate, as the turning characteristic, at least one of equivalent cornering power of the vehicle behavior control device with respect to the previous roll control gain and a delay time constant of a lateral force with respect to the previous roll control gain.

4. The vehicle control apparatus according to claim 3, wherein:
the estimation unit is configured to estimate the equivalent cornering power of the vehicle behavior control device in accordance with the previous roll control gain based on information indicating a relationship between the roll control gain and the equivalent cornering power, the information being stored in advance; and
the information indicating the relationship between the roll control gain and the equivalent cornering power is a relationship in which the equivalent cornering power decreases as the roll control gain increases a magnitude of tilting the vehicle body toward an outside of a turn.

5. A vehicle control method executed by a vehicle control apparatus that controls a vehicle behavior control device that is able to control a movement of a vehicle body in a roll direction, the vehicle control method comprising:
estimating a lateral acceleration generated in a vehicle; and
calculating information indicating a roll control gain for driving the vehicle behavior control device to move the vehicle body in the roll direction based on the lateral acceleration that is estimated,
wherein in the estimating, the lateral acceleration is estimated based on information indicating a previous roll control gain.
